(19) United States
(12) Patent Application Publication
(10) Pub. No.: US 2026/0035092 A1
(43) Pub. Date: Feb. 5, 2026

(54) Launch Apparatus for Aerial Objects

(71) Applicant: Gary Stout, Palmer, AK (US)

(72) Inventor: Gary Stout, Palmer, AK (US)

(21) Appl. No.: 19/284,140

(22) Filed: Jul. 29, 2025

Related U.S. Application Data
(60) Provisional application No. 63/678,894, filed on Aug. 2, 2024.

(51) Int. Cl. B64F 1/06

(52) U.S. Cl. CPC B64F 1/06

(57) ABSTRACT

A launch apparatus for aerial objects may include one or more base arms coupled to a base. A launching lever having a first end and a second end may be pivotally coupled to the base arms via a pivotal coupling. The launching lever may be movable from a tensioned position, in which a platform coupled proximate the second end is below the pivotal coupling, and a released position in which the platform is above the pivotal coupling. A weight may bias the launching lever to the released position. One or more launch pins coupled to the platform may be configured to be removably engaged to aerial objects. A lever lock and release mechanism may be operated to alternatively lock the launching lever in the tensioned position and to release the launching lever from the tensioned position causing the aerial objects to be uniformly jettisoned from the launch pins.

### CROSS REFERENCE TO RELATED APPLICATIONS

This application claims priority to and the benefit of the filing date of U.S. Provisional Application No. 63/678,894, filed on Aug. 2, 2024, entitled “Launch Apparatus for Aerial Objects”, which is hereby incorporated by reference in its entirety.

### FIELD OF THE INVENTION

This patent specification relates to the field of apparatuses for launching objects. More specifically, this patent specification relates to an apparatus for simultaneously launching two or more aerial objects.

### BACKGROUND

STEM (Science, Technology, Engineering, and Math) competitions are held regularly worldwide and are looked upon as a great way to encourage budding rocket scientists, or really anyone that may benefit from greater scientific knowledge. STEM competitions attempt to solve the problem of making learning STEM fun and engaging for individuals, particularly young aspiring scientists. Since learning and competition are important in promoting valuable life skills and boosting self-confidence, there exists an ever-present need for novel apparatuses that can be used in STEM competitions. A further need exists for novel apparatuses that provide a unique and exciting way for individuals to safely explore the principles of physics and engineering in a hands-on and interactive manner.

### BRIEF SUMMARY OF THE INVENTION

A launch apparatus for aerial objects is provided which may be used in STEM competitions that are held regularly worldwide and are looked upon as a great way to encourage budding rocket scientists, or really anyone that may benefit from greater scientific knowledge. In some embodiments, the apparatus may include a base configured to support the apparatus on a surface or object, and one or more base arms may be coupled to the base. A launching lever may be pivotally coupled to the one or more base arms via a pivotal coupling; and the launching lever may be elongated and may have a first end and an opposing second end. The pivotal coupling may be coupled to the launching lever proximate to the first end, and a platform may be coupled to the launching lever proximate to the second end. The launching lever may be movable into and between a tensioned position and a released position. When in the tensioned position the platform may be below the pivotal coupling, and when in the released position the platform may be above the pivotal coupling. Preferably, a weight may be coupled to the launching lever proximate to the first end, and the launching lever may be biased to the released position via the weight. A travel restrictor may be coupled to the launching lever and to one or more base arms. One or more launch pins may be coupled to the platform, and the launch pins may be configured to be removably engaged to aerial objects. A lever lock and release mechanism may be alternatively operable to both lock the launching lever in the tensioned position and to release the launching lever from the tensioned position. The travel restrictor may be configured to arrest the launching lever in the released position after the launching lever is released from the tensioned position causing the aerial objects to be uniformly jettisoned from the launch pins to allow them to freely travel through the air.

Numerous objects, features and advantages of the present invention will be readily apparent to those of ordinary skill in the art. Some example objects of the present invention are listed below.

One object of the present invention is to provide an apparatus that aims to solve the problem of making learning STEM (Science, Technology, Engineering, and Math) fun and engaging for individuals, particularly young aspiring rocket scientists. By incorporating elements of creativity, competition, and hands-on experimentation through gravity-powered rocket derbies, the invention addresses the challenge of fostering interest and enthusiasm in STEM fields among participants, while also promoting valuable life skills and boosting self-confidence. Additionally, the invention introduces an innovative approach to launching rockets using a catapult system, offering a unique and exciting way for individuals to explore the principles of physics and engineering in a hands-on and interactive manner.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a side perspective view of an example of a launch apparatus for aerial objects with its launching lever in a tensioned position according to various embodiments described herein.

FIG. 2—FIG. 2 illustrates another side perspective view of an example of a launch apparatus for aerial objects with its launching lever in a tensioned position according to various embodiments described herein.

FIG. 3—FIG. 3 shows a side perspective view of an example of a launch apparatus for aerial objects with its launching lever in a released position according to various embodiments described herein.

FIG. 4—FIG. 4 depicts a side perspective view of a portion of an example of a launch apparatus for aerial objects according to various embodiments described herein.

FIG. 5—FIG. 5 illustrates a rear perspective view of an example of a launch apparatus for aerial objects with its launching lever in a tensioned position according to various embodiments described herein.

FIG. 6—FIG. 6 shows a perspective view of an example platform and example aerial objects in which one launch pin and one aerial object are depicted in cross sectional view according to various embodiments described herein.

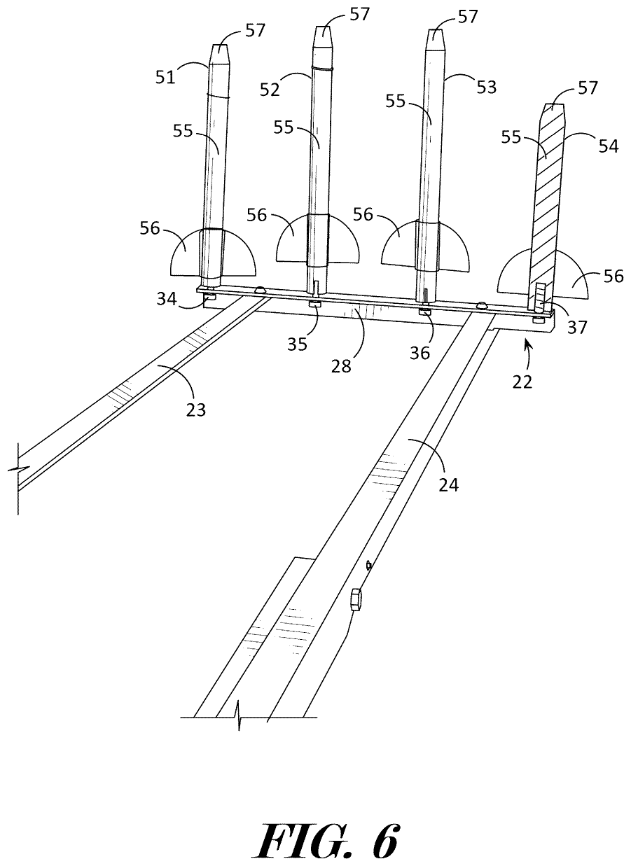

FIG. 7 depicts a perspective view of an example of a lever lock and release mechanism, an example of a trigger switch, and an example of a catch loop according to various embodiments described herein.

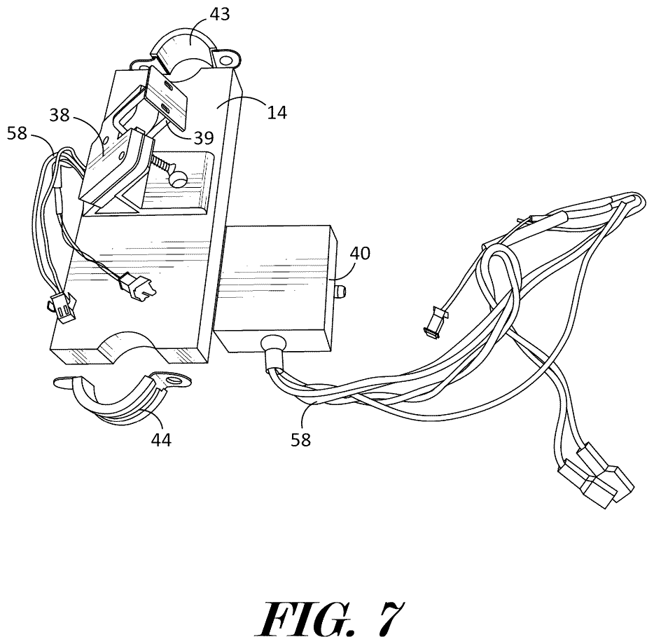

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

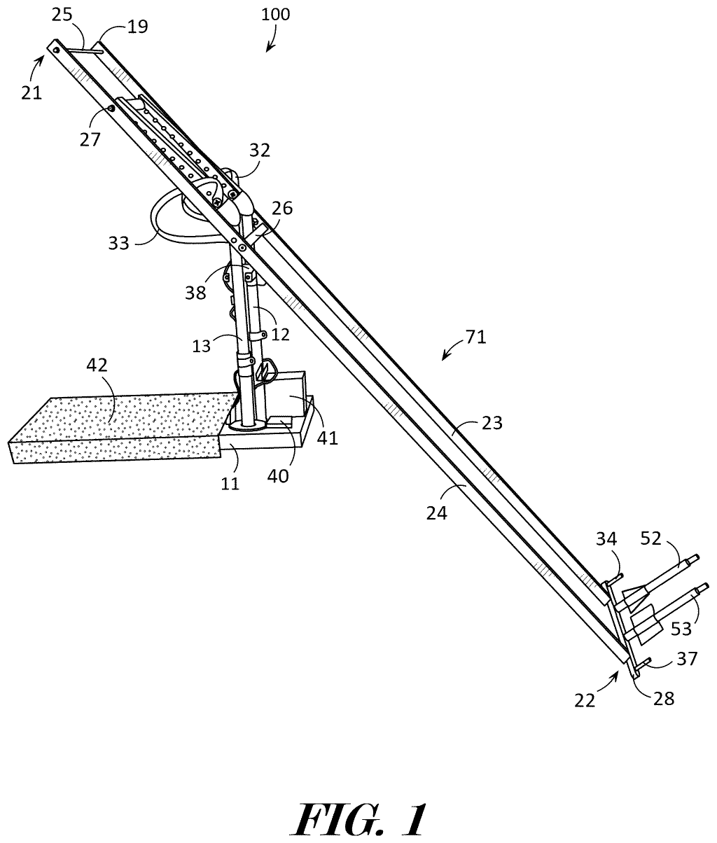

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new launch apparatus for aerial objects is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

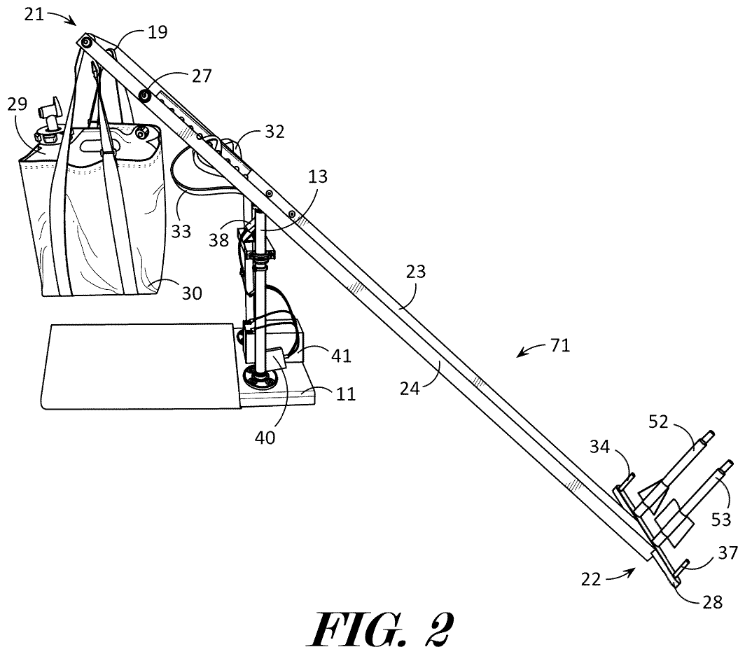

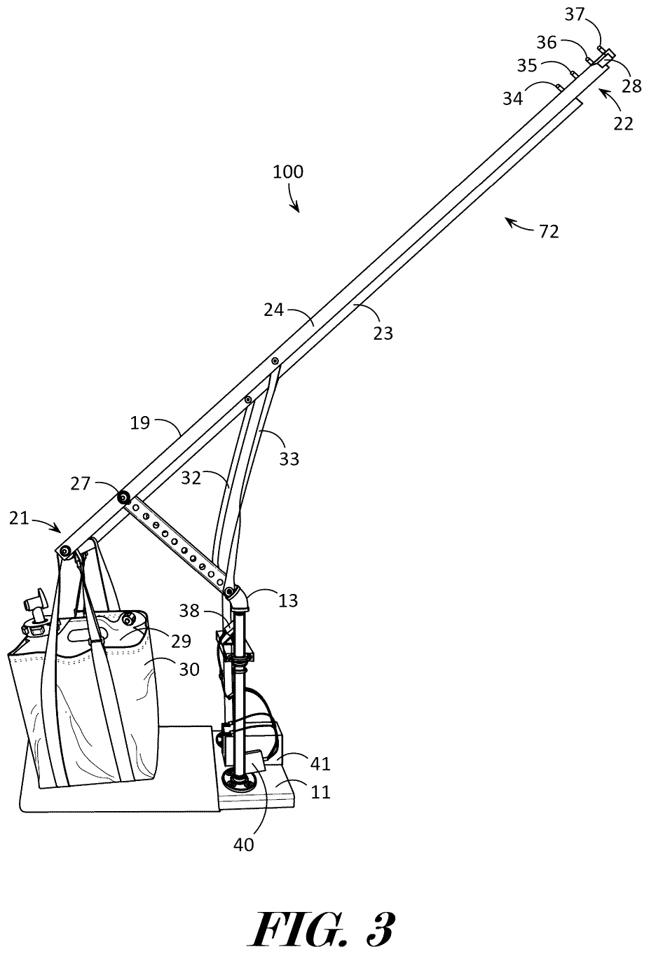

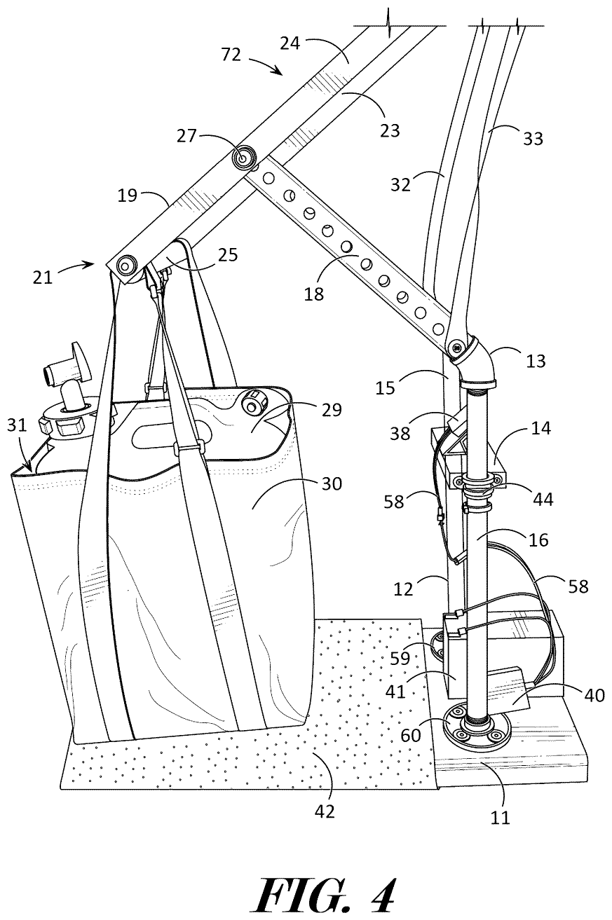

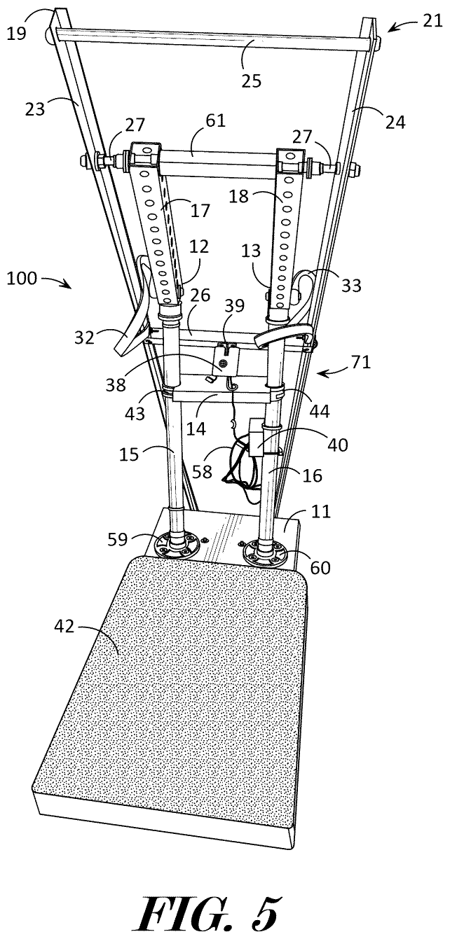

The present invention will now be described by example and through referencing the appended figures representing preferred and alternative embodiments. As perhaps best shown in FIGS. 1-5, an example of a launch apparatus for aerial objects (“the apparatus”) 100 according to various embodiments is illustrated. In some embodiments, the apparatus 100 may comprise a base 11, one or more base arms 12, 13, and a launching lever 19. The base 11 may be configured to support the apparatus 100 on a surface or object. Preferably, two base arms 12, 13, may be coupled to the base 11, and the launching lever 19 may be pivotally coupled to the base arms 12, 13, via a pivotal coupling 27. The launching lever 19 may be elongated and may have a first end 21 and an opposing second end 22. The pivotal coupling 27 may be coupled proximate to the first end 21, and a platform 28 may be coupled to the second end 22. A weight 29 may be coupled proximate to the first end 21, and a travel restrictor 32, 33, may be coupled to the launching lever 19 and to a base arm 12, 13. A plurality of launch pins 34, 35, 36, 37, may be coupled to the platform 28, and the launch pins 34, 35, 36, 37, may be configured to be removably engaged to aerial objects 51, 52, 53, 54. The launching lever 19 may be movable from a tensioned position 71 to a released position 72. When in the tensioned position 71, the platform 28 may be below the pivotal coupling 27, and when in the released position 72, the platform 28 may be above the pivotal coupling 27. A lever lock and release mechanism 38 may be operated to both lock the launching lever 19 in the tensioned position 71 and to release the launching lever 19 from the tensioned position 71. The launching lever 19 may be biased to the released position 72 via the weight 29, and the travel restrictor 32, 33, may arrest the launching lever 19 in the released position 72 causing the aerial objects 51, 52, 53, 54, to be uniformly jettisoned from the launch pins 34, 35, 36, 37, to allow them to freely travel through the air. Preferably, the travel restrictor 32, 33, may be configured to arrest the launching lever 19 in the released position 72 after the launching lever 19 is released from the tensioned position 71.

The apparatus 100 may comprise a base 11 that may be configured to support the apparatus 100 on a surface or object. A base 11 may be configured in any shape and size. Preferably, a base 11 may comprise a rectangular prism shape that may be made from or may comprise wood or other substantially rigid materials. Optionally, a base 11 may comprise a cushioning material 42, such as carpet, foam, padding, etc., which may provide cushioning functions, such as to cushion an impact of the weight 29 with the base 11.

The apparatus 100 may comprise one or more base arm(s) 12, 13, which may be configured to couple the launching lever 19 to the base 11. Preferably, two base arms 12, 13, may be coupled to the base 11, and the launching lever 19 may be pivotally coupled to the base arms 12, 13, via a pivotal coupling 27. Base arms 12, 13, may be configured in any size and shape. A base arm 12, 13, may be coupled to the base via any suitable coupling device or method, such as via a flange 59, 60, that may be coupled to the base via screws or other fasteners.

Optionally, a base arm 12, 13, may comprise a vertical section 15, 16, that may be coupled to the base 11, and an angled section 17, 18, that may be coupled to the launching lever 19 and to the one or more travel restrictors 32, 33. In some embodiments, a vertical section 15, 16, may be elongated (elongated in shape) so as to have a length that is significantly greater in dimension than the height and width dimensions. Similarly, in some embodiments, an angled section 17, 18, may be elongated (elongated in shape) so as to have a length that is significantly greater in dimension than the height and width dimensions. Optionally, an elongated vertical section 15, 16, may be coupled to the base 11 so that its elongated length is generally perpendicular to a surface that the base 11 is configured to rest on, e.g., such as perpendicular to a ground surface, table surface, etc. Optionally, an elongated angled section 17, 18, may be coupled to an elongated vertical section 15, 16, so that the elongated length of the angled section 17, 18, is angled between 0 and 45 degrees relative to the elongated length of the vertical section 15, 16. Preferably, an angled section 17, 18, may comprise a plurality of apertures which may be used to allow the launching lever 19 and travel restrictors 32, 33, to be repositionable coupled to different locations on the angled section 17, 18. Base arms 12, 13, may be made from or may comprise metal, wood, plastic, or any other substantially rigid material.

The apparatus 100 may comprise a launching lever 19 that preferably may be elongated and may have a first end 21 and an opposing second end 22. A launching lever 19 may be configured in any size and shape. In some embodiments, the launching lever 19 may comprise one or more lever arms 23, 24, and one or more lever cross braces 25, 26. Lever arms 23, 24, may extend from the first end 21 to the second end 22, while lever cross braces 25, 26, may join the lever arms 23, 24, together and provide structural rigidity to the launching lever 19. Lever arms 23, 24, and lever cross braces 25, 26, of a launching lever 19 may be made from or may comprise metal, wood, plastic, or any other substantially rigid material. In some embodiments, the apparatus 100 may comprise a first lever arm 23 23 that is elongated in shape and a second lever arm 24 is elongated in shape, and the elongated shape of the first lever arm 23 23 may be substantially parallel (plus or minus 10 degrees) to the elongated shape of the second lever arm 24.

The launching lever 19 may be movable coupled to one or more base arms 12, 13, via one or more pivotal couplings 27. The launching lever 19 may be movable from a tensioned position 71 to a released position 72 via a movable coupling between the launching lever 19 and one or more base arms 12, 13, provided by one or more pivotal couplings 27.

In some embodiments, the launching lever 19 may comprise a first lever arm 23 23 and a second lever arm 24, and the first lever arm 23 and the second lever arm 24 may each be coupled to a pivotal coupling 27. Preferably, the apparatus 100 may comprise a first base arm 12, a second base arm 13, a first lever arm 23, and a second lever arm 24, and the base arms 12, 13, may be pivotally coupled to the base arms 12, 13, via a pivotal coupling 27. Preferably, the pivotal coupling(s) 27 may be coupled to the launching lever 19 proximate to the first end 21 so that the pivotal coupling(s) 27 may be positioned closer to the first end 21 than to the second end 22.

In preferred embodiments, a pivotal coupling 27 may comprise a pivot pin that extends through the first base arm 12, the second base arm 13, the first lever arm 23, and the second lever arm 24. For example, the pivotal coupling 27 may comprise a pivot pin that extends through an aperture in the first base arm 12, an aperture in the second base arm 13, an aperture in the first lever arm 23, and an aperture in the second lever arm 24. In preferred embodiments, a pivotal coupling 27 may comprise a fastener, such as a bolt, screw, rivet, pin, etc., while may both couple the launching lever 19 to a base arm 12, 13, and which may provide an axle around which the launching lever 19 may pivot or rotate. In further embodiments, a pivotal coupling 27 may comprise a hinge, bearing, axle, or any other coupling device or method which may allow the launching lever 19 may pivot or rotate between the tensioned position 71 and released position 72. In further embodiments, a pivotal coupling 27 may comprise a hinged coupling such as butt hinge, butterfly hinge, flush hinge, barrel hinge, concealed hinge, continuous hinge, T-hinge, strap hinge, double-acting hinge, Soss hinge, a flexible material hinge, or any other hinge. In still further embodiments, a pivotal coupling 27 may comprise a pivotal or rotating coupling such as a rivet, bearing, knuckle joint, universal joint, male ball joint and female socket joint, or any other pivotal or rotating coupling, or any other method of movably coupling two objects together so that one object may be moved, pivoted, rotated, or the like, relative to the other object.

The apparatus 100 may comprise a platform 28 that preferably may be coupled to the launching lever 19, such as to one or more lever arms 23, 24. Optionally, a platform 28 may be coupled proximate to the second end 22 of the launching lever 19 so that the platform 28 is relatively closer to the second end 22 than to the pivotal coupling(s) 27. Optionally, a platform 28 may be coupled proximate to the second end 22 of the launching lever 19 so that the platform 28 is coupled to the second end 22. When in the tensioned position 71, the platform 28 may be below the pivotal coupling 27, and when in the released position 72, the platform 28 may be above the pivotal coupling 27. A platform 28 may comprise a structure of any size and shape to which a plurality of launch pins 34, 35, 36, 37, may be coupled so that each launch pin 34, 35, 36, 37, may move in a path that is substantially equidistant to the path that the other launch pins 34, 35, 36, 37, of the plurality of launch pins 34, 35, 36, 37, move in when the launching lever 19 is moved into and between the tensioned position 71 and the released position 72. As an example, a platform 28 may comprise an elongated length of metal or other rigid material bar stock that may be coupled to one or more lever arms 23, 24, so that the elongated length of the platform 28 is substantially parallel to the pivot axis provided by the one or more pivotal couplings 27. In some embodiments, the launching platform 28 may be coupled to both the first lever arm 23 and the second lever arm 24.

One or more, such as a plurality of, launch pins 34, 35, 36, 37, may be coupled to the platform 28, and the launch pins 34, 35, 36, 37, may be configured to be removably engaged to aerial objects 51, 52, 53, 54. Preferably, a portion of a launch pin 34, 35, 36, 37, may be inserted into a hollow bottom or base of an aerial object 51, 52, 53, 54, so that this interaction and the action of gravity may removably engage an aerial object 51, 52, 53, 54, to a launch pin 34, 35, 36, 37. The launch pins 34, 35, 36, 37, may be configured in any size and shape, such as a cylindrical shape. Two or more, such as each, launch pin 34, 35, 36, 37, may be configured with a substantially identical size and shape so as to not confer any advantage to launching an aerial object 51, 52, 53, 54, from the different launch pins 34, 35, 36, 37. Preferably, the apparatus 100 may comprise four launch pins 34, 35, 36, 37, that may be slotted 7/16 coupling nuts that interface internally with the elongated body 55 proximate to the portion of the elongated body 55 that the fins 56 of an aerial object 51, 52, 53, 54, are coupled in order to ensure proper angular placement. In preferred embodiments, the apparatus 100 may comprise a plurality of launch pins 34, 35, 36, 37, and each launch pin 34, 35, 36, 37, of the plurality of launch pins 34, 35, 36, 37, may be substantially equidistant from the pivotal coupling 27 that movably couples the launching lever 19 to the base arms 12, 13. In preferred embodiments, the apparatus 100 may comprise a plurality of launch pins 34, 35, 36, 37, and each launch pin 34, 35, 36, 37, of the plurality of launch pins 34, 35, 36, 37, may be substantially equidistant from the pivot axis (a line or point around which the launching lever 19 rotates or pivots when moving into and between tensioned position 71 and released position 72) provided by one or more pivotal couplings 27 that movably couple the launching lever 19 to the base arms 12, 13.

In some embodiments, the apparatus 100 may comprise one or more weights 29 that may be coupled to the launching lever 19, and the launching lever 19 may be biased to or into the released position 72 via the weight 29. In preferred embodiments, the apparatus 100 may comprise a weight 29 that may be coupled proximate to the first end 21 of the launching lever 19. Optionally, a weight 29 may be coupled proximate to the first end 21 of the launching lever 19 so that the weight 29 is relatively closer to the first end 21 than to the pivotal coupling(s) 27. Optionally, a weight 29 may be coupled proximate to the first end 21 of the launching lever 19 so that the weight 29 is coupled to the first end 21. Preferably, the pivotal coupling(s) 27 may act as a fulcrum for the launching lever 19, and the launching lever 19 may be biased to the released position 72 via the weight 29. In some embodiments, the platform 28 may be coupled to the second end 22 of the launching lever 19 and a weight 29 may be coupled to the first end 21 of the launching lever 19.

A weight 29 may be configured in any size and shape, and may be configured to have a mass that is preferably larger than twenty pounds. In preferred embodiments, a weight 29 may comprise a tank or container that may be configured to hold or contain a desired volume of water or other liquid, such as a 7-gallon jug that may be filled with liquid to weigh approximately 57 pounds. In further embodiments, a weight 29 may comprise a solid material such as metal plates, concrete weights, wood weights, etc.

A weight 29 may be coupled to the launching lever 19 via any suitable coupling device or method. In some embodiments, the apparatus 100 may comprise a weight container 30 having a cavity 31, and the weight container 30 may be coupled to the launching lever 19 proximate to the first end 21 and the weight 29 may be positioned in the cavity 31. Optionally, a weight container 30 may be coupled proximate to the first end 21 of the launching lever 19 so that the weight container 30 is relatively closer to the first end 21 than to the pivotal coupling(s) 27. Optionally, a weight container 30 may be coupled proximate to the first end 21 of the launching lever 19 so that the weight container 30 is coupled to the first end 21. A weight container 30 may comprise any container or other object that may be used to hold objects. Preferably, the weight 29 may be coupled or held to the launching lever 19 via a weight container 30 that may comprise a bag or flexible satchel. Generally, a bag or flexible satchel may be a container made of flexible material with an opening at the top, used for carrying things. In further embodiments, any other coupling method or device may be used to couple a weight 29 to the launching lever 19.

In some embodiments, the apparatus 100 may comprise one or more travel restrictors 32, 33, which may be configured to govern the position of the released position 72 relative to the tensioned position 71. Generally, the travel restrictor(s) 32, 33, may arrest the launching lever 19 in the released position 72 as it moves out of the tensioned position 71 causing the aerial objects 51, 52, 53, 54, to be uniformly jettisoned from the launch pins 34, 35, 36, 37, to allow them to freely travel through the air.

In some embodiments, a travel restrictor 32, 33, may be coupled to the launching lever 19 and to a base arm 12, 13. In further embodiments, a travel restrictor 32, 33, may be coupled to the launching lever 19 and to a base 11. In preferred embodiments, the apparatus 100 may comprise two travel restrictors 32, 33, that may each be coupled to the launching lever 19 (e.g., one travel restrictor 32, 33, coupled to each lever arm 23, 24,) and to a base arm 12, 13.

Preferably, travel restrictors 32, 33, may comprise a resilient material. Generally, a resilient material may be flexible to deformation and resilient so as to return to its original shape after deformation. In some embodiments, a travel restrictor 32, 33, may comprise a resilient rubber strap, a resilient silicone strap, or other shape of resilient material. In preferred embodiments, a travel restrictor 32, 33, may comprise a resilient rubber strap having a length dimension, and the length dimension of the rubber strap may dictate the position of the released position 72 and the resilient nature of the rubber strap may moderate the arresting force of the rubber strap on the launching lever 19 as it enters the released position 72. In further embodiments, a travel restrictor 32, 33, may comprise a spring, rope, flexible cord, resilient cord, bumper, stop, or other structure or device which may arrest the launching lever 19 and govern the position of the released position 72 relative to the tensioned position 71.

The apparatus 100 may comprise a lever lock and release mechanism 38 that may be operated to alternatively lock the launching lever 19 in the tensioned position 71 and to release the launching lever 19 from the tensioned position 71. In preferred embodiments, a lever lock and release mechanism 38 may comprise an electrically operated solenoid, such as an electric door lock solenoid, that may catch and release a catch loop 39 or other structure that may be coupled to a lever cross brace 25, 26, or other element of a launching lever 19, and the lever lock and release mechanism 38 may be operated by a user via a trigger switch 40. A trigger switch 40 may comprise an electrical switch having a button, rocker arm, toggle, or other user input that may be used to operate the switch. An electrically operated solenoid may comprise a coil of wire, often cylindrical, that acts like a magnet when electricity passes through it. When current flows, such as enabled by a trigger switch 40, it creates a magnetic field that can be used to pull a movable core or plunger into the coil. This motion can be used to actuate switches, valves, or other mechanical devices. In further embodiments, a lever lock and release mechanism 38 may comprise any other type of trigger and release mechanism, including by being manually operated.

In some embodiments, the apparatus 100 may comprise a lever cross brace 26 that may be coupled to both the first lever arm 23 and the second lever arm 24, and a catch loop 39 may be coupled to the lever cross brace 26. The lever cross brace 26 may be coupled to the lever arms 23, 24, so that it is positioned between the pivotal coupling(s) 27 and the second end 22. The lever lock and release mechanism 38 may be configured to engage with the catch loop 39 to lock the launching lever 19 in the tensioned position 71, and the lever lock and release mechanism 38 may be configured to disengage with the catch loop 39 to release the launching lever 19 from the tensioned position 71. A catch loop 39 may comprise a loop of material, such as a metal D-loop, which may be selectively engaged to the lever lock and release mechanism 38 so that the lever lock and release mechanism 38 may selectively catch and release the catch loop 39. In further embodiments, the apparatus 100 may comprise any other structure or device which may be selectively engaged to an electrically operated solenoid device.

A lever cross brace 25, 26, may comprise a structure of any shape and size that may extend between and be coupled to two lever arms 23, 24. Preferably, a lever cross brace 25, 26, may comprise an elongated length of metal bar stock or other substantially rigid material, such as wood, plastic, etc.

The apparatus 100 may comprise one or more base cross braces 14, 61, that may be coupled to one or more portions of a base arm 12, 13. In some embodiments, a pivotal coupling 27 may be coupled to an upper base cross brace 61, and the upper base cross brace 61 may be coupled to the two base arms 12, 13, such as to angled sections 17, 18. Preferably, the lever lock and release mechanism 38 may be coupled to a lower base cross brace 14, and the lower base cross brace 14 may be coupled to the base arms 12, 13, such as to vertical sections 15, 16. A base cross brace 14, 61, may comprise a structure of any shape and size that may extend between and be coupled to two base arms 12, 13. Preferably, a base cross brace 14, 61, may comprise an elongated length of wood or other substantially rigid material. Optionally, a lower base cross brace 14 may be coupled to the base arms 12, 13, via one or more clamps 43, 44. Clamps 43, 44, may be configured in any shape and size. Preferably, a clamps 43, 44, may comprise a curved shape to extend around a portion of a cylindrical section of a base arm 12, 13, and the lower base cross brace 14 may comprise concave cut outs to receive a portion of the cylindrical section of a base arm 12, 13, that may be clamped to the lower base cross brace 14 via a clamps 43, 44. Optionally, a clamp 43, 44, may comprise a rubber pad or other friction enhancing material.

The apparatus 100 may comprise a power source 41 that is configured to provide electrical power to the lever lock and release mechanism 38. A trigger switch 40 may be in electronic communication (e.g., via wiring 58) with the power source 41 and with the lever lock and release mechanism 38, and the trigger switch 40 may be operable to govern the electrical power provided to the lever lock and release mechanism 38 to disengage with the catch loop 39. The power supplied to the lever lock and release mechanism 38 may be controlled by the trigger switch 40, so that operating the trigger switch 40 may operate the lever lock and release mechanism 38 to release the catch loop 39 resulting in the launching lever 19 being released from the tensioned position 71. In some embodiments, a power source 41 may comprise a 12-volt battery, and the trigger switch 40 may control the power delivery to operate the lever lock and release mechanism 38. In some embodiments, a power source 41 may comprise a battery, such as a lithium-ion battery, nickel cadmium battery, alkaline battery, or any other suitable type of battery, a fuel cell, a capacitor, a super capacitor, or any other type of electricity storing and/or releasing device. In further embodiments, a power source 41 may comprise a power cord, kinetic or piezo electric battery charging device, a solar cell or photovoltaic cell, and/or inductive charging or wireless power receiver.

In some embodiments, the apparatus 100 may be used with and/or may comprise one or more aerial objects 51, 52, 53, 54. An aerial object 51, 52, 53, 54, may comprise an object that is configured to fly through the air. In preferred embodiments, an aerial object 51, 52, 53, 54, may comprise a rocket shape that comprises an elongated body 55 and at least one fin 56 (more preferably two or more fins 56) coupled to the elongated body 55. A typical rocket shape is a long cylinder (elongated body 55) with a conical nose cone. A usually cylindrical body 55 is usually optimized for structural integrity and internal space for components like fuel tanks and other objects. The conical nose cone is designed to reduce aerodynamic drag as the rocket travels through the atmosphere. Fins 56 at the base provide stability and control. In further embodiments, an aerial object 51, 52, 53, 54, may comprise an airplane shape, a glider shape, or any other shape that is configured to fly through the air.

In some embodiments, the apparatus 100 may comprise one or more aerial objects 51, 52, 53, 54, that may be removably coupled to a launch pin 34, 35, 36, 37. Preferably, an aerial object 51, 52, 53, 54, may be removably coupled to one launch pin 34, 35, 36, 37. An aerial object 51, 52, 53, 54, may be removably coupled to a launch pin 34, 35, 36, 37, so that the aerial object 51, 52, 53, 54, may remain coupled to the launch pin 34, 35, 36, 37, when the launch platform 28 and launching lever 19 are in the tensioned position 71 and so that the aerial object 51, 52, 53, 54, uncouples from the launch pin 34, 35, 36, 37, when the launch platform 28 and launching lever 19 are moved into the released position 72. In preferred embodiments, an aerial object 51, 52, 53, 54, may be removably coupled to a launch pin 34, 35, 36, 37, by a portion of the launch pin 34, 35, 36, 37, being inserted into a portion of the aerial object 51, 52, 53, 54. For example, the base of the elongated body 55 may be hollow or comprise an aperture that may receive a launch pin 34, 35, 36, 37, to couple the elongated body 55 to the launch pin 34, 35, 36, 37, when the launch platform 28 and launching lever 19 are in the tensioned position 71 and so that the elongated body 55 uncouples from the launch pin 34, 35, 36, 37, when the launch platform 28 and launching lever 19 are moved into the released position 72. In further embodiments, any other removable coupling method may be used to perform the same removable coupling function. For example, a launch pin 34, 35, 36, 37, may comprise a slot to removably couple or engage with a portion of a fin 56 and/or a portion of the elongated body 55. As another example, a launch pin 34, 35, 36, 37, may comprise a cavity 31 to removably couple or receive a portion of a fin 56 and/or a portion of the elongated body 55.

Preferably, the apparatus 100 may enable aerial objects 51, 52, 53, 54, to be uniformly jettisoned from the launch pins 34, 35, 36, 37, to allow them to freely travel through the air in unique trajectories that are dictated by the unique design, shape, size, and elements of the respective aerial objects 51, 52, 53, 54. Key features of the apparatus 100 may include the travel restrictors 32, 33, preferably comprising rubber straps, that cause an improved, consistent and equal release of two or more, such as four, aerial objects 51, 52, 53, 54, (e.g., Gravity Powered Rocket Shaped Projectiles). For this reason, the apparatus 100 is ideally suited for use in STEAM competitions in which individuals build their own unique aerial objects 51, 52, 53, 54, preferably configured as rockets, air planes, gliders, or other flying objects, in order to accomplish goals, such as longest flight distance, longest flight time, highest altitude, longest distance traveled, etc. The apparatus 100 may be used to introduce participants to simple machines and basic physics concepts, making it an educational tool for learning and exploration.

Preferable characteristics of aerial objects 51, 52, 53, 54, include the following: safety is of utmost importance, so propellers, explosives and even batteries are ruled out; nosecones are a resilient rubber, so they bounce and resilience is one of the major advantages; mounting of the rubber nosecone is also novel, as is the internal viewable weights that may move or be locked stationary; transparent polycarbonate also may allow a small astronaut to be seen through a cockpit window; the maximum weight of each rocket is 3 ounces and the fuselage is 8 inches in length; the young scientists are deemed Gravity Wizards; the creation of each aerial object 51, 52, 53, 54, is unique, like the derby cars; and the fins 56 especially are prone to customization and are ideal projects to print on 3 dimensional printers.

Unique Elements and Functions of a launch apparatus for aerial objects 100 that is configured to launch aerial objects 51, 52, 53, 54, may include:
1. Gravity-Powered Air Derbies: The concept of engaging in gravity-powered air derbies, similar to pine wood derbies but with rockets, is a unique and innovative approach to combining physics education with hands-on experimentation and competition.
2. Rubber Nosecones with Bounce Feature: The use of resilient rubber nosecones on the rockets (aerial objects 51, 52, 53, 54) that bounce upon impact introduces an element of luck and durability to the rockets, making them distinct from traditional rocket designs.
3. Customizable Fin 56 Designs: The opportunity to customize fin 56 designs on the rockets, utilizing 3D printing technology, allows for creativity and personalization by participants, setting the invention apart from other rocket launching systems.
4. Catapult Lever Mechanism: The incorporation of a catapult lever mechanism in the launching system introduces participants to simple machines and basic physics principles, offering an educational component that distinguishes the invention from conventional rocket launchers.
5. Multiple Award Categories: The establishment of various award categories, such as Bounce Wizard, Flight Wizard, and Art Wizard, adds a unique competitive element to the air derbies, encouraging diverse skills and creativity among participants.
6. Transparent Polycarbonate Rockets: The use of transparent polycarbonate material for the body 55 of aerial objects 51, 52, 53, 54, allows for a small astronaut figurine to be seen through a cockpit window, enhancing the visual appeal and educational value of the aerial objects 51, 52, 53, 54.
7. Integration of STEAM Education: By incorporating Art into the STEM acronym (Science, Technology, Engineering, Art, and Math), the invention promotes a holistic approach to learning and creativity, setting it apart as a comprehensive educational tool.

These unique elements and functions collectively contribute to the distinctive nature of the launch apparatus for aerial objects apparatus 100, offering a novel and engaging platform for STEM education, creativity, and competition in a way that sets it apart from existing inventions in the field.

The launch apparatus for aerial objects 100 (sometimes called Gravity-Powered Rocket Launching System) may be a novel apparatus designed to facilitate gravity-powered air derbies, where participants can launch rockets using a catapult mechanism. The system comprises a twin-arm launcher with rubber straps that ensure an improved, consistent, and equal release of preferably four aerial objects 51, 52, 53, 54, (Gravity Powered Rocket Shaped Projectiles (GPRSPs)). The launching lever 19, incorporating a slow-moving heavy object, accelerates a small number of aerial objects 51, 52, 53, 54, skyward quickly.

Safety is a key feature of the invention, as propellers, explosives, and batteries are ruled out. The aerial objects 51, 52, 53, 54, preferably feature resilient rubber nosecones 57 that bounce upon impact, enhancing their durability and adding an element of luck to the competitions. Preferably, each aerial object 51, 52, 53, 54, has a maximum weight of 3 ounces and a fuselage length of 8 inches, making them suitable for young participants referred to as “Gravity Wizards.” The rockets' fins 56 are customizable, providing an opportunity for creativity and innovation, especially through the use of 3D printing technology. The catapult system introduces participants to simple machines and basic physics concepts, making it an educational tool for learning and exploration.

The competitive aspect of the invention includes various categories for winning, such as the Bounce Wizard for lucky bounce landings, Flight Wizard for the longest distance flown before impact, and Art Wizard for artistic design. The apparatus 100 also allows for the incorporation of additional awards based on creativity and unique features of the rockets. Overall, the apparatus 100 (Gravity-Powered Rocket Launching System) offers a fun, engaging, and educational platform for fostering interest in STEM fields and encouraging innovation and creativity among participants.

In preferred embodiments, the apparatus 100 may include one or more of the following components:
a) Twin-arm launching lever 19 with rubber straps (travel restrictors 32, 33)
b) aerial objects 51, 52, 53, 54 (Gravity Powered Rocket Shaped Projectiles (GPRSPs))
c) Rubber nosecones 57
d) Rockets (fuselage/body 55, fins 56)
e) Catapult lever mechanism
f) Rubber straps for launcher 2.0 (travel restrictors 32, 33)
g) Transparent polycarbonate for rockets' body 55
h) Padded carpet base 11
i) Slotted cylindrical launch pins 34, 35, 36, 37,
j) weight 29 (e.g., 7-gallon jug (preferably approximately 57 pounds))
k) Viewable weights
l) Mounting mechanism for rubber nosecone 57
m) Lever for catapult system
n) Customizable fin 56 designs
o) STEM educational materials and guidelines
p) Award ribbons (Bounce Wizard, Flight Wizard, Art Wizard)
q) Branded merchandise opportunities

In some embodiments, the apparatus 100 may include one or more of the following non-essential or optional components:
a) Small astronaut figurine for cockpit window
b) Remote-controlled flight surfaces on gliders
c) Geek Football landing craft demonstration
d) High-resolution slow-motion video recording equipment
e) Sponsor logos on the 7-gallon bag
f) Fancy shop equipment or art supplies for rocket customization
g) Additional awards for contest categories
h) Instant replay viewing for rocket launches
i) Informational website domains (GravityWizards.com, GravityWizards.org)
j) Company names (Gravity Powered Rocket Corporation, Gravity Wizards Inc.)

While some exemplary shapes and sizes have been provided for elements of the apparatus 100, it should be understood to one of ordinary skill in the art that the base 11, base arms 12, 13, launching lever 19, platform 28, weight 29, travel restrictor 32, 33, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the apparatus 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the apparatus 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the apparatus 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the apparatus 100 may be coupled by being one of connected to and integrally formed with another element of the apparatus 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A launch apparatus for aerial objects, the apparatus including:
a base configured to support the apparatus on a surface or object;
at least one base arm that is coupled to the base;
a launching lever that is pivotally coupled to the at least one base arm via a pivotal coupling; wherein the launching lever is elongated and has a first end and an opposing second end, wherein the pivotal coupling is coupled to the launching lever proximate to the first end, wherein a platform is coupled to the launching lever proximate to the second end, wherein the launching lever is movable into and between a tensioned position and a released position, wherein when the launching lever is in the tensioned position the platform is below the pivotal coupling, and wherein when the launching lever is in the released position the platform is above the pivotal coupling;
a travel restrictor coupled to the launching lever and the at least one base arm;
a plurality of launch pins coupled to the platform; and
a lever lock and release mechanism that is alternatively operable to both lock the launching lever in the tensioned position and to release the launching lever from the tensioned position, wherein the travel restrictor is configured to arrest the launching lever in the released position after the launching lever is released from the tensioned position.

2. The apparatus of claim 1, wherein the travel restrictor comprises a resilient material.

3. The apparatus of claim 1, wherein the launching lever comprises a first lever arm and a second lever arm, and wherein the first lever arm and the second lever arm are each coupled to the pivotal coupling.

4. The apparatus of claim 3, wherein the first lever arm is elongated in shape and the second lever arm is elongated in shape, and wherein the elongated shape of the first lever arm is substantially parallel to the elongated shape of the second lever arm.

5. The apparatus of claim 3, wherein the platform is coupled to both the first lever arm and the second lever arm.

6. The apparatus of claim 3, further comprising a lever cross brace that is coupled to both the first lever arm and the second lever arm, wherein a catch loop is coupled to the lever cross brace, wherein the lever lock and release mechanism is configured to engage with the catch loop to lock the launching lever in the tensioned position, and wherein the lever lock and release mechanism is configured to disengage with the catch loop to release the launching lever from the tensioned position.

7. The apparatus of claim 3, wherein the pivotal coupling comprises a pivot pin that extends through the at least one base arm, the first lever arm, and the second lever arm.

8. The apparatus of claim 1, wherein the lever lock and release mechanism comprises an electrically operated solenoid.

9. The apparatus of claim 8, further comprising a power source that is configured to provide electrical power to the lever lock and release mechanism.

10. The apparatus of claim 9, further comprising a trigger switch that is in electronic communication with the power source and with the lever lock and release mechanism.

11. The apparatus of claim 10, wherein the trigger switch is operable to govern the electrical power provided to the lever lock and release mechanism to disengage with the catch loop.

12. The apparatus of claim 1, wherein each launch pin of the plurality of launch pins are substantially equidistant from the pivotal coupling.

13. The apparatus of claim 1, further comprising an aerial object that is removably coupled to a launch pin of the plurality of launch pins.

14. The apparatus of claim 13, wherein the aerial object is removably coupled to the launch pin of the plurality of launch pins by a portion of the launch pin being inserted into a portion of the aerial object (may need figure).

15. The apparatus of claim 13, wherein the aerial object comprises an elongated body and at least one fin coupled to the elongated body.

16. The apparatus of claim 1, further comprising a weight coupled to the launching lever, wherein the launching lever is biased to the released position via the weight.

17. The apparatus of claim 16, wherein the weight comprises a tank configured to contain a volume of a liquid.

18. The apparatus of claim 16, wherein the weight is coupled to the launching lever proximate to the first end of the launching lever.

19. The apparatus of claim 16, wherein the platform is coupled to the second end and the weight is coupled to the first end.

20. The apparatus of claim 16, further comprising a weight container having a cavity, wherein the weight container is coupled to the launching lever proximate to the first end, and wherein the weight is positioned in the cavity.
